(19) United States
(12) Patent Application Publication
(10) Pub. No.: US 2016/0016822 A1
(43) Pub. Date: Jan. 21, 2016

(54) METHOD AND DEVICE FOR PROCESSING CIP MEDIA

(71) Applicant: KHS GMBH, Dortmund (DE)

(72) Inventor: Elke Vetter, Grünstadt (DE)

(21) Appl. No.: 14/770,527

(22) PCT Filed: Feb. 13, 2014
(86) PCT No.: PCT/EP2014/000395

§ 371 Date: Aug. 26, 2015

(30) Foreign Application Priority Data
Feb. 28, 2013 (DE) 10 2013 102 017.8

(51) Int. Cl. C02F 1/28; B67C 7/00; B01D 15/08

(52) U.S. Cl. CPC C02F 1/285; B01D 15/08; B67C 7/0073; C02F 2101/30

(57) ABSTRACT

A method for processing liquid CIP media used in plants for treating containers includes promoting adsorption of aromatic substances from said CIP media by exposing the CIP media to a polymeric adsorbent material.

### RELATED APPLICATIONS

This application is the national stage under 35 USC 371 of international application PCT/EP2014/000395, filed on Feb. 13, 2014, which claims the benefit of the Feb. 28, 2013 priority date of German application DE 10 2013 102 017.8.

### FIELD OF INVENTION

The invention concerns container processing, and in particular, cleaning container-processing equipment.

### BACKGROUND

Container-treatment machines, such as filling machines for filling containers with beverages or other liquid products, require regular cleaning and/or disinfection using cleaning media and/or disinfectants. This cleaning process is often “cleaning in place,” or “CIP cleaning. Different kinds of CIP media are used in CIP cleaning.

The CIP media is stored in a media supply unit. During cleaning, the CIP media is fed into the filling machine through a CIP header. The various media then flow through the regions of the filling machine that are to be cleaned and/or disinfected. The CIP media is then returned to the CIP supply unit to be re-used.

In some cases, a filling machine will be used to fill different products. For example, after having filled bottles with a first product for some time, a filling machine may be pressed into service to fill other bottles with a second product. In such cases, thorough cleaning is particularly important because of the risk that aromatic compounds from the first product will taint the second product.

It has thus far not been possible to completely prevent aromatic compounds from tainting another product. The worst offenders are non-polar aromatic compounds. These include aldehydes, ketones, esters, phenols, anisoles and hetero-aromatics. These compounds tend to collect in regions of pipes and/or channels of the filling machine that convey the product, and in particular, on or in components made of polymeric or elastomeric material, such as seals.

To minimize the likelihood of such contamination, CIP media must be frequently replaced. This increases costs. In addition, because of the difficulty of completely removing such aromatics, a filling machine is usually not used to fill with products whose tastes are too different. This reduces plant flexibility.

### SUMMARY

The invention provides a method for removing aromatic compounds that might otherwise accumulate in CIP media. Examples of such aromatic compounds include aldehydes, ketones, esters, phenols, anisoles and/or hetero-aromatics. These are either removed or at least reduced in concentration using adsorbent polymeric material to an extent that avoids tainting the product to be filled with off-flavors. Suitable adsorbent polymeric materials include cross-linked polymers approved for use with foodstuffs and having a solid or elastic aggregate state. A particularly useful adsorbent polymeric material is polyethylene.

In one aspect of the invention, aromatic compounds are reduced in or removed from the particular CIP media by direct contact between the adsorbent polymeric material and the CIP media to be treated. This is achieved in a variety of ways. Examples include using the adsorbent polymeric material in an installation through which the CIP media flows and/or in a space occupied by the CIP media, such as a chamber, tank, or a device container.

In another aspect, the invention features a method for processing liquid CIP media used in plants for treating containers. Such a method includes promoting adsorption of aromatic compounds from CIP media that has been tainted by aromatic compounds. This includes exposing the media to a polymeric adsorbent material. One suitable material is polyethylene.

Other practices include exposing the media to adsorbent polymeric material in granulated form, exposing the media to adsorbent polymeric material in the form of a film, exposing the media to adsorbent polymeric material in the form of a preform, exposing the media to adsorbent polymeric material in the form of a mesh, exposing the media to adsorbent polymeric material in the form of a lattice, and exposing the media to adsorbent polymeric material in powdered form.

Also among the practices of the invention are those in which any one or more of aldehydes, ketones, esters, phenols, anisoles, and hetero-aromatics has tainted the media.

Yet other practices include using an amount of adsorbent polymeric material that depends on the amount of CIP media to be cleaned. A particularly useful range of amounts is the range between 2 g/L-200 g/L, and preferably, the range between g/L to 60 g/L, where g is the quantity of the adsorbent polymeric material in grams and L is the quantity of the CIP media to be cleaned or processed in liters.

Other practices include exposing the media to the polymeric adsorbent material in a CIP return flow.

Yet other practices include, after exposing the media, returning the media to a unit that supplies the CIP media.

Additional practices include exposing the media within a cleaning circuit of a unit for supplying the CIP media.

In some practices, exposing the media to a polymeric adsorbent material comprises supplying the adsorbent polymeric material in a space that holds the CIP media.

In another aspect, the invention features an apparatus for cleaning CIP media. Such an apparatus includes an adsorption unit configured to hold a polymeric adsorbent material for exposure to aromatic compounds.

In some embodiments, the adsorption unit comprises a tank, and a filter that receives bulk adsorbent polymeric material and causes the material to be held immobile.

As used herein, “aromatic compound” includes aromatic substances such as aromatic hydrocarbons.

As used herein, “processing of CIP media” or “cleaning of CIP media” means the removal or reduction in concentration of aromatic compounds from the CIP media. Moreover, as used herein, “removal of off-flavors from halogenated anisoles and phenols” means, in particular, the removal of the off-flavors commonly described as “corked” flavors.

As used herein, the expressions “substantially” or “approximately” mean deviations from exact values in each case by ±10%, and preferably by ±5% and/or deviations in the form of changes not significant for functioning.

Although the term “media” is technically the plural form of “medium,” no such distinction is made here. The term “media” is used in its collective form and is intended to include one or more distinct species of solution.

A particular advantage of processing CIP media as described herein is that it does not involve attempting to remove aromatic compounds from the product itself. This means it is not necessary to ensure that sufficient quantities of desired aromatic compounds remain in the product. Thus the method described herein does not need to discriminate between different aromatic compounds. This considerably simplifies both process management and selection of absorption and adsorption agents. This is particularly significant for the removal of off-flavors due to halogenated anisoles and phenols from wine or products containing wine because contact between the adsorption agent and the wine must be limited to being between 4 and 48 hours, and preferably between 12 and 24 hours.

### BRIEF DESCRIPTION OF THE FIGURES

These and other features of the invention will be apparent from the following detailed description and the accompanying figures, in which:

FIG. 1 shows a plant with a filling machine and a unit for CIP media source for use in CIP cleaning of the container treatment machine; and

FIG. 2 in a schematic representation of a polymer structure of an adsorbent polymeric material with aromatic compounds held in this structure by adsorption.

### DETAILED DESCRIPTION

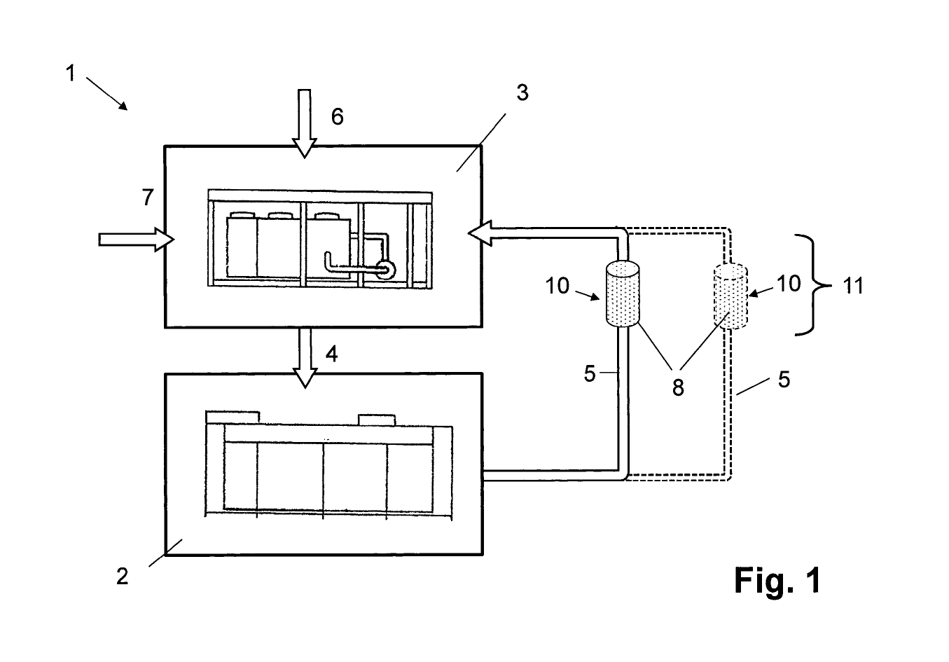

FIG. 1 shows a plant 1 with a container-treatment machine 2, and in particular, a filling machine for filling bottles or other containers with liquid products or beverages. The container-treatment machine 2 is used for filling containers with products of different kinds and/or of different flavors. These products include those that are rich in aromatic compounds, such as wine and products containing wine.

A media source 3 supplies liquid CIP media to the container-treatment machine 2. The media source includes an optional first inlet 6 for intake of fresh water and water vapor and a second inlet 7 for intake of lye and acid concentrate.

CIP media includes cleaning media, disinfectants, and combinations thereof. The CIP media is used during CIP cleaning of the container-treatment machine 2. During such CIP cleaning, the CIP media flows through the container-treatment machine 2. As it does so, it comes into contact with surfaces that also contact the product.

CIP cleaning often involves using different CIP media in a particular sequence. A typical procedure begins with an initial rinsing with demineralized water, e.g. water having a hardness of 4° dH. This is followed by introduction of aqueous alkaline solution, such as soda lye. Optional steps of intermediate rinsing with demineralized water and rinsing with acid follow. Suitable acids include nitric acid and phosphoric acid. A final rinsing step includes another rinse with demineralized water.

The CIP media enters the container-treatment machine 2 through a CIP inlet 4 and leaves the container-treatment machine 2 through a CIP outlet 5. The flow from the CIP outlet 5 is the CIP return flow. From there, the used CIP media returns to the media source 3 for separate collection and processing. The media are then saved in a holding tank for later use.

The CIP cleaning of the container-treatment machine 2 takes place before a change of the product that the container-treatment machine 2 will be processing. This avoids having components of a first product, and in particular, its aromatic compounds, from mixing with a second product. Doing so suppresses the likelihood that the second product will be adversely affected by off-flavors.

A problem in some container-treatment machines 2 is that aromatic compounds from the products can be deposited in certain components of the container handling machine 2, for example in seals of the pipes or channels conveying the product. During subsequent filling of a second product, these can be released into the second product, thus causing unwanted off-flavors in the second product.

An additional problem is that instead of being released into the second product, these aromatic compounds are released into the CIP media. Since the CIP media is fed back to the media source 3 and reused, there exists a possibility that the concentration of aromatic compounds will increase in the CIP media itself, thus impairing its ability to clean.

To prevent this, the plant 1 features an adsorption unit 11 to clean or process the CIP media by adsorption of the aromatic compounds in an adsorbent polymeric material 8.

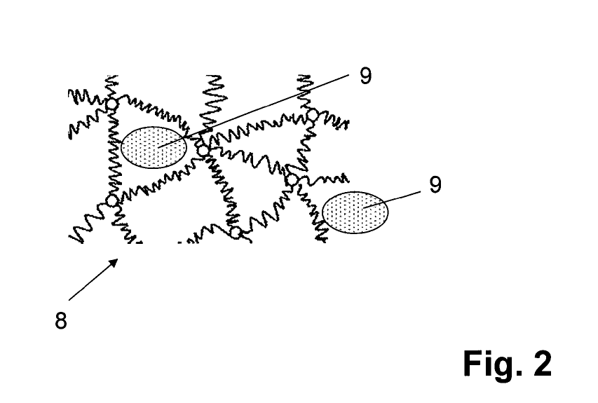

As illustrated schematically in FIG. 2, the adsorption of the aromatic compounds 9 occurs by their deposition into the polymer structure of the adsorbent polymeric material 8. In some embodiments, the material is polyethylene, and the polymer structure is formed by the polymer chains.

The adsorption unit 11 for processing CIP media comprises a filter installation 10 that is provided in the CIP return flow downstream from the CIP outlet 5. Where multiple CIP media are used, one or more additional CIP return flows with such filters 10 are provided. These are allocated either to each species of CIP media, when multiple species are used, or to a set of species of CIP media that are similar enough to process together.

The filter 10 contains adsorbent polymeric material 8. Embodiments include those in which the adsorbent polymeric material 8 is in the form of a granulate. Preferably, the granulate is kept in a structure through which CIP media can flow. Examples include a cartridge and a porous pouch or bag filled with the granulate.

The adsorbent polymeric material 8 can also be in the form of a film, such as a filmstrip. Or it can be cast or extruded as a preform, as a membrane, as a mesh, or as a lattice. The adsorbent polymeric material 8 can also be used in powdered form.

Although a typical adsorbent polymeric material 8 can process considerable amounts of CIP media, it does not last forever. Thus, it is necessary to replace it at regular intervals, and in particular, no later than by the time it reaches the end of its adsorption capacity.

The location at which treatment of CIP media occurs can be moved. It is not always necessary to carry out treatment following the CIP return flow 5.

It is thus possible to treat the CIP media with the adsorbent polymeric material 8 not in the CIP return flow 5, but instead of this, or in addition to this, to undertake the treatment with the adsorbent polymeric material 8 inside the media source 3 or in another part of the plant 1, for example by using the adsorbent polymeric material 8 in a treatment circuit of the media source 3 or by supplying the adsorbent polymeric material 8 in a device container or in a chamber to which the CIP media is fed back by means of the CIP return flow 5.

The adsorption unit 11 carries out the task of removing aromatic compounds 9 using adsorbent polymeric material 8. In some embodiments, the adsorption unit 11 includes a tank or container and a filter 10. Adsorbent polymeric material 8 is introduced as a bulk product. Alternatively, a molded body is secured so that it holds the material 8 immobile and in position.

In an alternative device, the adsorbent polymeric material 8 flows with the CIP media at least for a partial section or in a pipe region suitable for this, after which it is held back or separated from the CIP media by an appropriate separator unit.

In some embodiments or practices, either the adsorption unit 11 or the adsorbent polymeric material 8 is regenerated.

Having described the invention, and a preferred embodiment thereof, what is new, and secured by letters patent is:

1-10. (canceled)

11. A method for processing liquid CIP media used in plants for treating containers, said method comprising promoting adsorption of aromatic compounds from said CIP media that has been tainted with aromatic compounds, wherein promoting adsorption comprises exposing said media to a polymeric adsorbent material.

12. The method of claim 11, wherein exposing said media to a polymeric adsorbent material comprises exposing said media to polyethylene.

13. The method of claim 11, wherein exposing said media to a polymeric adsorbent material comprises exposing said media to adsorbent polymeric material in a form selected from the group consisting of granulated form, film form, in the form of a preform, in the form of a mesh, in the form of a lattice, in powdered form.

14. The method of claim 11, wherein said media has been tainted by an aromatic compound selected from the group consisting of aldehydes, ketones, esters, phenols, anisoles, and hetero-aromatics.

15. The method of claim 11, further comprising using an amount of adsorbent polymeric material that depends on the amount of CIP media to be cleaned, wherein said amount is within a range of 2 g/L-200 g/L, where g is the quantity of the adsorbent polymeric material in grams and L is the quantity of the CIP media to be cleaned or processed in liters.

16. The method of claim 11, further comprising using an amount of adsorbent polymeric material that depends on the amount of CIP media to be cleaned, wherein said amount is within a range of 6 g/L to 60 g/L, where g is the quantity of the adsorbent polymeric material in grams and L is the quantity of the CIP media to be cleaned or processed in liters.

17. The method of claim 11, wherein exposing said media to a polymeric adsorbent material comprises exposing said media to said polymeric adsorbent material in a CIP return flow.

18. The method of claim 17, further comprising, after exposing said media, returning said media to a unit that supplies said CIP media.

19. The method of claim 11, wherein exposing said media to a polymeric adsorbent material comprises exposing said media within a cleaning circuit of a unit for supplying said CIP media.

20. The method of claim 11, wherein exposing said media to a polymeric adsorbent material comprises supplying said adsorbent polymeric material in a space holding said CIP media.

21. An apparatus for cleaning CIP media, said apparatus comprising an adsorption unit configured to hold a polymeric adsorbent material for exposure to aromatic compounds.

22. The apparatus of claim 21, wherein said adsorption unit comprises a tank, and a filter that receives bulk adsorbent polymeric material and causes said material to be held immobile.
